(19) United States
(12) Patent Application Publication
(10) Pub. No.: US 2006/0033612 A1
(43) Pub. Date: Feb. 16, 2006

(54) Vehicle door damage prevention device

(76) Inventor: Richard Santa, Hagerstown, MD (US)

Correspondence Address: Richard Santa, PO BOX 111, Cavetown, MD, 21720, US

(21) Appl. No.: 11/197,843

(22) Filed: Aug. 5, 2005

Related U.S. Application Data
(60) Provisional application No. 60/600,792, filed on Aug. 12, 2004.

(51) Int. Cl. B60Q 1/00; B60K 28/00; G08B 21/00

(52) U.S. Cl. 340/435; 340/686.6; 180/271

(57) ABSTRACT

The present invention is a device to prevent damage to a vehicle door by sensing the presence of an object and preventing a door from being opened and contacting the sensed object. The device consists of a proximity sensor attached to the edge of a vehicle's door that sends a signal at a preset distance from any object that it could come in contact with to a control box, which converts the sensor signal into electric power which will activate a device located in the hinge area of the door that will engage a lock to stop the outward swing of the door.

This application claims priority of the provisional allocation No. 60/600,792 filed on Aug. 12, 2004

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING

Not Applicable

### BACKGROUND OF THE INVENTION

This invention generally relates to a device that prevents damage to a vehicle door, specifically a device that senses the presence of an object and prevents a vehicle door from being damaged by opening it into an object in it's path. The device would sense the distance of an opening door in relation to an object within its projected arc or path of travel, and prevent damage by engaging a mechanical door stop.

Many devices have been proposed for an apparatus to sense an object and prevent a vehicle door from being opened and hitting into that object which may cause damage. However, these devices are limited in their functionality and do not function as effectively as the present invention. It is therefore an object of the present invention to provide an improved and universal device to prevent a vehicle door from being damaged by sensing an object and preventing a vehicle door from being opened and contacting the sensed obstruction.

### BRIEF SUMMARY OF THE INVENTION

The present invention provides a new and useful device that can be installed and used to sense an adjacent object to the vehicle and prevent a vehicle door from being opened and contacting the object, which could cause damage. The invention is simple in construction, universally usable and more versatile in operation than any known apparatus or device. It consists of a proximity sensor attached to the edge or part of the door that leads the outward door swing, and would be very close to the first part to come in contact with any surface within the arc of the opening door. The sensor would be connected to a simple electronic control box or relay that will convert the sensor signal into electric power that will activate a device located in the hinge area of the door, which engages a lock to stop the outward swing or opening of the door. It may consist of a gear engaging or pin engaging device, a friction device, or a hydraulic stop, and may be activated by a solenoid or electric motor. The device may have a positive stop followed by a spring or hydraulic cushion which would prevent any jarring effects by a quick stop of the door. Many override parameters may be built into the system. This entire operation can be temporarily overridden to prevent an inappropriate sensor signal from a person opening the door from the outside, may be turned on and off as desired, and shut down in the event of an accident.

In reference to above, it is understood that while this may describe the present invention, it is not limited to the method or detail of construction, fabrication, material, or application of use described and illustrated herein. Any other variation of fabrication, use, or application can be considered apparent as an alternative embodiment of the present invention

### BRIEF DESCRIPTION OF THE DRAWINGS

FIG. 1. is a cutaway front view of an installed apparatus to sense an object and prevent a vehicle door from being opened and hitting into the sensed obstruction object which may cause damage according to the present invention.

FIG. 2. is a cutaway view of an apparatus to sense an object and prevent a vehicle door from being opened and hitting into the sensed obstruction object which may cause damage according to the present invention.

FIG. 3. is a basic flow chart of an apparatus to sense an object and prevent a vehicle door from being opened and hitting into the sensed obstruction object which may cause damage according to the present invention.

### DETAILED DESCRIPTION OF THE INVENTION

Referring now descriptively to the drawings, the attached figures illustrate an apparatus to sense an object and prevent a vehicle door from being opened and hitting into that object which may cause damage.

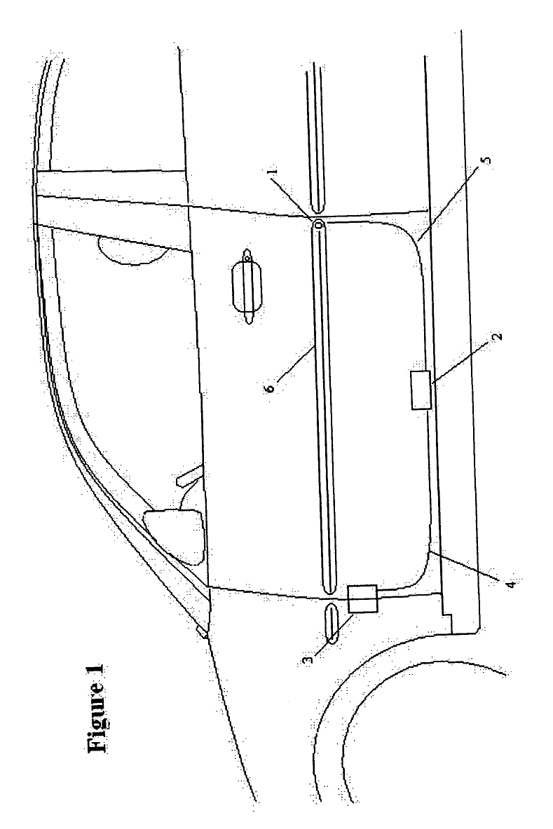

FIG. 1 illustrates an apparatus to sense and prevent a vehicle door from being opened and hitting into an object which may cause damage according to the present invention. The proximity sensor 1 is located in the door at a location that allows for the earliest obstruction sensing during the swing of an opening door. It is located in the door's bump protector 6 in this instance. When opening the door and the sensor 1 receives a proximity alert from an object in the path of the outward swinging door, it will send a signal to a control box 2 via the connection wire 5. The control box 2 will take the sensors alert signal and trigger the door swing stopping mechanism 3 via the connection wire 4. This procedure will continue until the sensor 1 is moved away from the obstruction object by closing the door. At this time the sensor 1 will cease to alert the control box 2 and ultimately the door swing lock 3 will release.

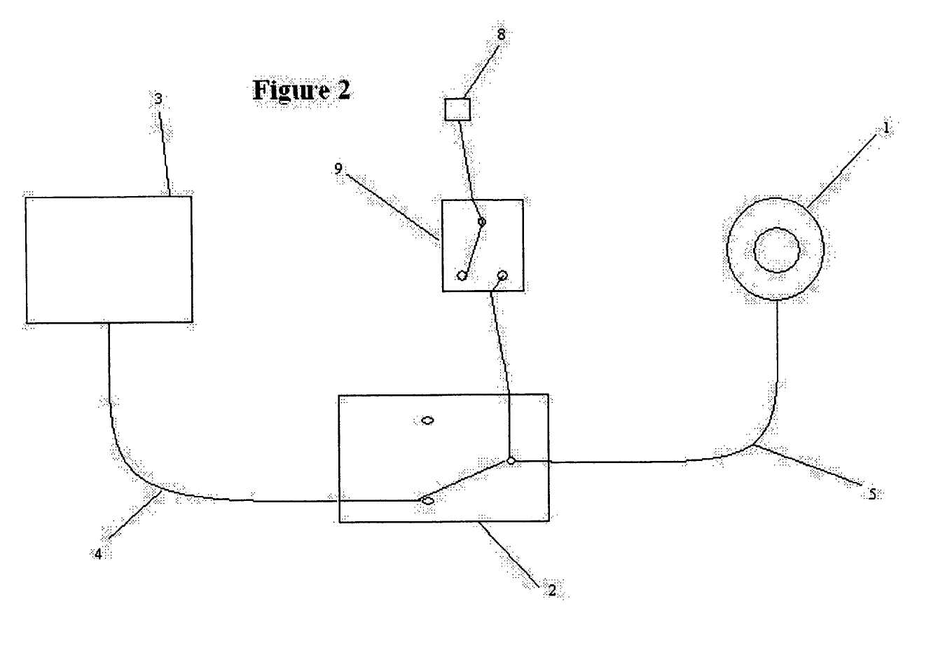

FIG. 2 includes the above procedures with a closer look at a possible control box 2 solution. The control box 3 is a relay that is activated by the sensor 1 and will route vehicle power 8 to a solenoid door swing lock 3. Any overriding parameters such as the vehicle being in a drive gear or a manual on or off switch will block 9 the incoming power to the control box.

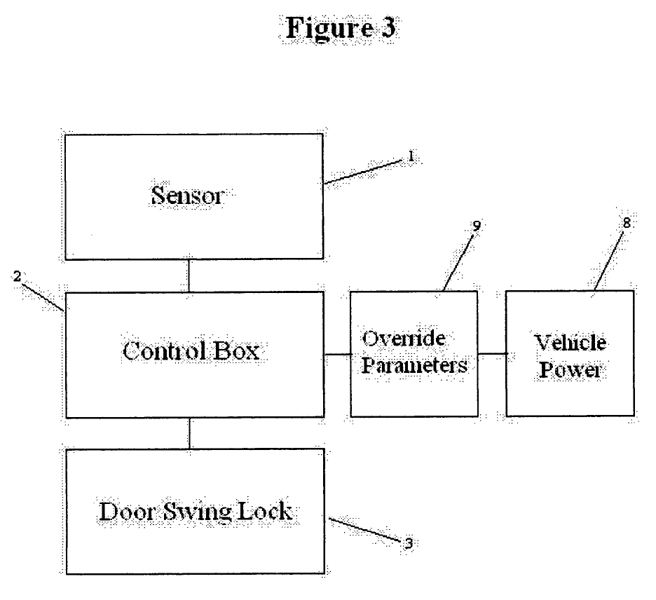

FIG. 3 is a simple flow chart of the apparatus to sense and prevent a vehicle door from being opened and hitting into an object which may cause damage.

I claim:

1. A vehicle door damage prevention device, consisting of a proximity sensor, which senses an object close to a door and sends a signal to a control box, which converts the signal into electric power and activates a device that engages a lock to stop the door from opening.

2. A device as described in claim number 1 herein, whereas the device is for Original Equipment Manufacturer (O.E.M.) purposes.

3. A device as described in claim number 1 herein, whereas the device is for aftermarket purposes.

4. A device as described in claim number 1 herein, whereas the device is made of any combination of wire, plastic, rubber, metal, or materials.

5. A device as described in claim number 1 herein, whereas the device also senses moving objects approaching the vehicle door.

6. A device as described in claim number 1 herein, whereas the device also activates an audible alarm to alert the close proximity of a sensed object.

7. A device as described in claim number 1 herein, whereas the device can consist of a gear or pin engaging stop device or a friction or hydraulic stop that can be activated by an solenoid or an electric motor.

8. A device as described in claim number 1 herein, whereas the device may have a positive stop followed by a spring or hydraulic cushion to prevent any jarring effects of a quick stop to the door.

9. A device as described in claim number 1 herein, whereas the device will not interfere with traditional operational practices of a vehicle door until the door enters a predetermined distance from an obstruction.

10. A device as described in claim number 1 herein, whereas the device can be applied to all the outward or upward swinging doors of any vehicle, or on any powered opening swinging doors.
